(19) United States
(12) Patent Application Publication
(10) Pub. No.: US 2021/0180321 A1
(43) Pub. Date: Jun. 17, 2021

(54) SYSTEM AND METHOD OF MANUFACTURING A PANEL

(71) Applicant: HERMAN MILLER, INC., Zeeland, MI (US)

(72) Inventors: Shannon McDevitt, Grand Rapids, MI (US); Jack Frick, Hudsonville, MI (US); John Curtis Groelsma, Jenison, MI (US)

(21) Appl. No.: 17/119,254

(22) Filed: Dec. 11, 2020

Related U.S. Application Data
(60) Provisional application No. 62/947,241, filed on Dec. 12, 2019.

(51) Int. Cl. E04C 2/24; D04H 1/435; D04H 1/4274; D04H 1/06

(52) U.S. Cl. CPC E04C 2/246; D04H 1/435; D10B 2505/00; D04H 1/06; D04H 1/4274

(57) ABSTRACT

A method of manufacturing a panel includes obtaining a textile scrap, the textile scrap consisting essentially of polyester, mechanically separating the textile scrap into a plurality of textile yarns, where each of the plurality of textile yarns has a first melting point that is greater than a first temperature, and obtaining a plurality of staple fibers, where the plurality of staple fibers includes bicomponent fibers each having a melting point that is less than the first temperature. The method further includes blending the plurality of textile yarns with the plurality of staple fibers to form a mixed blend of textile yarns and staple fibers, and heating and compressing the mixed blend to form the panel.

### CROSS-REFERENCES TO RELATED APPLICTIONS

This application claims priority to U.S. Provisional Application No. 62/947,241, filed on Dec. 12, 2019, the entire contents of which are incorporated by reference herein.

### FIELD OF THE INVENTION

The present disclosure relates to systems and methods of manufacturing a panel, and more particularly manufacturing a panel including polyester scrap material.

### BACKGROUND

Textile fabrics are used for numerous products across several different industries. Many textiles used to make products are made with or include polyester materials, which have a variety of different benefits. However, polyester can take a long time to decompose. Additionally, the process of making many of these products may result in scrap material that is often thrown away.

### SUMMARY

In one embodiment, the disclosure provides a method of manufacturing a panel. The method includes obtaining a textile scrap, the textile scrap consisting essentially of polyester, mechanically separating the textile scrap into a plurality of textile yarns, where each of the plurality of textile yarns has a first melting point that is greater than a first temperature, and obtaining a plurality of staple fibers, where the plurality of staple fibers includes bicomponent fibers each having a melting point that is less than the first temperature. The method further includes blending the plurality of textile yarns with the plurality of staple fibers to form a mixed blend of textile yarns and staple fibers, and heating and compressing the mixed blend to form the panel.

In other embodiments, the disclosure provides a screen including a panel consisting essentially of a plurality of polyester textile yarns from a textile scrap, where the plurality of polyester textile yarns being non-homogeneous and having a first melting point that is greater than a first temperature, and a plurality of staple fibers, the plurality of staple fibers being homogeneous and having a melting point that is less than the first temperature, wherein the plurality of polyester textile yarns and the plurality of staple fibers are blended and bonded together.

In yet other embodiments, the disclosure provides a screen assembly including a first panel including a first side, a second side, and an edge extending around a perimeter of the first and second sides, and a second panel coupled to the first panel, where the second panel includes a first side, a second side, and an edge extending around a perimeter of the first and second sides, and wherein the first side of the second panel faces the first side of the first panel. A first fabric layer extends around the second side of the first panel, and a second fabric layer extends around the second side of the second panel. A first mount is coupled to the first side of the first panel, where the first mount includes a recess for receiving excess fabric from the first fabric layer. A second mount is coupled to the first side of the second panel, where the second mount includes a recess for receiving excess fabric from the second fabric layer, and wherein the second mount engages with the first mount.

Other aspects of the disclosure will become apparent by consideration of the detailed description and accompanying drawings.

### BRIEF DESCRIPTION OF THE DRAWINGS

FIG. 1 is flow chart of a method of manufacturing a panel according to one embodiment.

FIG. 2 illustrates a cross-section of a monocomponent textile yarn according to one embodiment.

FIG. 3 illustrates a cross-section of a bicomponent staple fiber according to one embodiment.

FIG. 4A is a perspective view of a panel according to one embodiment.

FIG. 4B is a side view of the panel of FIG. 4A.

FIG. 5 is a flow chart of a method of manufacturing a panel according to another embodiment.

FIG. 6A is a first perspective view of panel with a layer of fabric wrapped around an outside side of the panel.

FIG. 6A is a second perspective view of the panel of 6A with a layer of fabric wrapped around an outside side of the panel.

FIG. 7A is a schematic cross-sectional view of a panel including a facing, where the cross-section is taken along a plane generally parallel to the side of the panel.

FIG. 7B is a schematic cross-sectional view of the panel of FIG. 7A including a facing, where the cross-section is taken along a plane generally perpendicular to the side of the panel.

FIG. 8A is a schematic cross-sectional view of a screen according to one embodiment.

FIG. 8B is a schematic cross-sectional view of a screen according to another embodiment.

FIG. 8C is a schematic cross-sectional view of a screen according to another embodiment.

FIG. 8D is a schematic cross-sectional view of a screen according to another embodiment.

FIG. 9 is a perspective view of a screen constructed according to one embodiment.

FIG. 10 is a plan view of a naked screen included in the screen construction of FIG. 9.

FIG. 11 is a perspective view of a portion of the naked screen of FIG. 10 including cutouts according to one embodiment.

FIG. 12 is a plan view of the screen of FIG. 9 including hardware and corner mounts.

FIG. 13 is a detailed view of the hardware and corner mounts of FIG. 12.

FIG. 14A is a first perspective view of a corner mount according to one embodiment.

FIG. 14B is a second perspective view of the corner mount of FIG. 14A.

FIG. 15 is a plan view of the screen of FIG. 10.

FIG. 16 is a detailed view of a portion of the screen shown in FIG. 15.

FIG. 17 is a detailed view of a screen construction including hanging hardware.

FIG. 18 is a cross-sectional view taken along the line 18-18 of FIG. 17.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

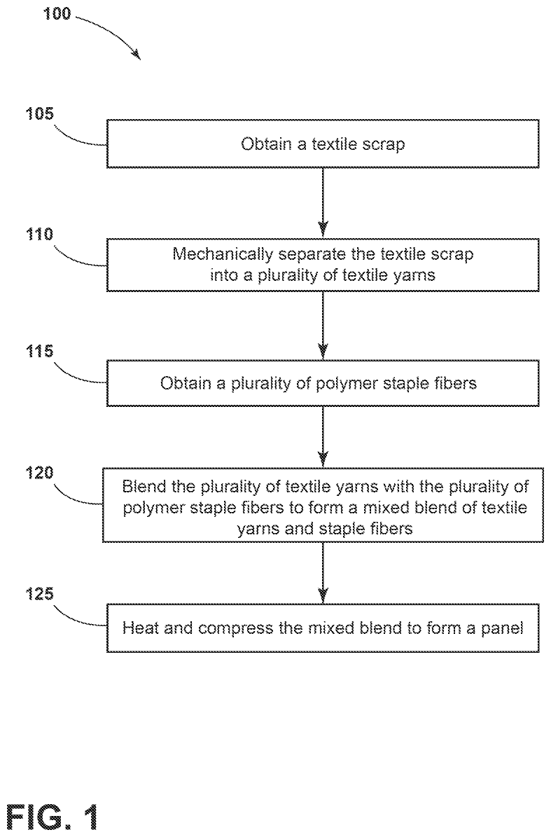

FIG. 1 illustrates a method of manufacturing a panel. Although the method includes specific steps, all of the steps need not be performed or performed in the order presented. In some embodiments, the method may include other steps or may not include all of the steps depicted. Additionally or alternatively, the steps may be performed in different orders. The panel may be used as a naked panel or in a screen, as described herein.

The method 100 includes the step of obtaining a textile scrap (step 105). The textile scrap may consist essentially of polyester. That is, the textile scrap may be mainly composed of polyester, but may include some impurities or stray fibers from other materials. In other embodiments, the textile scrap may consist essentially of other polymers or a combination of polymers. For example, the textile scrap may include polypropylene. The method 100 also includes the step of mechanically separating the textile scrap into a plurality of textile yarns (step 110), where each of the textile yarns has a first melting point that is greater than a first temperature. In some embodiment, the plurality of textile yarns are non-homogeneous. In other words, the textile yarns are not necessarily the same shape, size, color, texture, etc. In some embodiments, the textile yarns may be considered unprocessed textile yarns, in that the textile yarns are not re-melted, re-polymerized, rewoven, and the like. Rather, the textile yarns are only mechanically processed by cutting and opening (e.g., combing) the yarns. The method 100 further includes the step of obtaining a plurality of polymer staple fibers (step 115). The staple fibers may be bicomponent fibers each having a melting point that is less than the first temperature. The method 100 then includes the step of blending the textile yarns with the staple fibers to form a mixed blend of textile yarns and staple fibers (step 120). In some embodiments, the mixed blend may be formed (e.g., stacked) into a mat or sheet. Finally, the method includes the step of heating and compressing the mixed blend to form the panel (step 125).

In step 105 of the method 100, the textile scrap may be obtained from scrap materials that are left over from manufacturing processes that utilize textiles. In some embodiments, the textile scrap may be obtained from excess materials used during the manufacture of furniture. For example, excess upholstery fabric from chairs, couches, carpets, room separators, privacy panels, or other furniture may be used. In other embodiments, the textile scrape may be obtained from other industries, such as apparel, footwear, carpeting, curtains, and the like. The textile scrap may be obtained as either scrap material that is excess during the manufacturing process, or alternatively, may be obtained from preexisting products made with textiles. For example, when a product, such as a piece of furniture, becomes old or is no longer needed, the textile from the product may be removed and used in the method disclosed in FIG. 1. The textile scrap may be obtained from multiple different sources, resulting in multiple textiles of different types, colors, and textures.

The textile scrap may be a woven textile, a knit textile, or a non-woven textile. The textile scrap may include yarns of varying denier and/or varying lengths. The yarns of the textile scrap may be textured yarns, such as twisted, yarns, crimped yarns, air textured yarns, or other textures. Additionally, the yarns of the textile scrap may be non-homogenous, having a combination of denier, length, texture and colors.

The textile scrap obtained for use in the method 100 is composed of polyester yarns. Alternatively, the yarns may be other types of polymer yarns, such as polypropylene yarns. However, as noted above, the textile scrap may include imperfections or contaminants that are incidental to the (mostly) polyester textile. As used herein, the term yarns may refer to one or both warp yarns and weft yarns. The yarns of the textile scrap have a melting point that is above the first temperature. For example in some embodiments, the melting point of the textile yarns may be above 250° C. The melting point of yarns in the textile scrap may not be the same for each yarn. For example, some of the yarns in the textile scrap may have greater or lower melting point temperature than other yarns in the textile scrap. The first temperature is representative of a temperature that is lower than the melting point of the textile yarns with the lowest melting point.

After the textile scrap is obtained (step 105), the method 100 includes the step of mechanically separating the textile scrap (step 510). The separating process includes any known method of deconstructing the textile into separate pieces. For example, mechanically separating may include chopping or cutting the textile scrap into pieces. In some embodiments, the textile scrap is chopped into pieces of the same size, while in other embodiments, the textile scrap is chopped into pieces of varying sizes. The chopped pieces may have different lengths or widths. In some embodiments, the textile scrap is chopped into pieces having a length less than or greater than a predetermined length or width. For example, the textile scrap may be chopped into pieces having a length less than 90 mm. Similarly, in some embodiments, the textile scrap is chopped into piece having the same shape as one another, while in other embodiments, the textile scrap is chopped into pieces having varying shapes. The pieces may be cut into geometric shapes, such as rectangles, triangles, or circles. Alternatively, the pieces may be cut into random or irregular shapes.

In other embodiments, mechanically separating may also or alternatively include pulling apart the textile scrap. Pulling apart, or combing, helps separate individual yarns of the textile scrap from each other. Pulling apart the textile scraps may also open each yarn. The separated yarns may remain loosely connected together as chunks of yarns. In further embodiments, mechanically separating may include other known processes.

The separated textile yarns remain unprocessed. In other words, the separated textile yarns are not treated or further manipulated beyond being mechanically deconstructed. For example, in some embodiments, the unprocessed textile yarns are not manipulated beyond being chopped and combed. For example, the unprocessed textile yarns do not receive any chemical or heat treatment for the purpose of altering the structure of the textile yarns. However, in some embodiments, a chemical flame retardant may be added to the unprocessed textile yarns for the purpose of making the panel flame resistant or reduce smoke. In this embodiment, the chemical flame retardant is not intended to alter the textile yarns, but is merely an additive to the overall composition of the panel. The unprocessed textile yarns may be non-homogenous such that they have different properties, such as different lengths, denier, texture, and melting point temperatures.

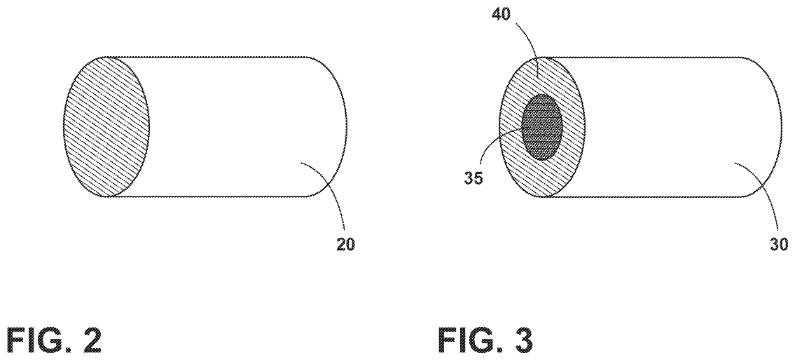

Additionally, in some embodiments, the textile yarns may include monocomponent fibers. In other embodiments, the textile yarns may be exclusively monocomponent fibers. Each monocomponent fiber is composed of a single strand of material. The monocomponent fibers are each composed of a uniform material (e.g., polyester). FIG. 2 illustrates one example of a monocomponent fiber 20.

Referring back to FIG. 1, the method 100 further includes the step of obtaining a plurality of polymer staple fibers (step 115). Suitable polymer bi-component fibers are commercially available under the trade designation “PET bi-component fiber.” Similar to the textile yarns, the polymer staple fibers may include imperfections or contaminants that are incidental to the (mostly) polymer staple fiber. In the illustrated embodiment, the staple fibers are bicomponent or multicomponent fibers having two or more fibers with different melting points. FIG. 3 illustrate one embodiment of a biocomponent staple fiber 30. In the embodiment shown in FIG. 3, the staple fiber 30 is a bicomponent fiber having an inner strand or core 35 on an inner diameter portion of the staple fiber 30 and an outer sheath 40 on an outer diameter portion of the staple fiber. The outer sheath 40 surrounds the inner core 35. In some embodiments, the staple fiber 30 may have an outer diameter of 40 denier or smaller. In other embodiments, the staple fiber 30 may have an outer diameter between 1.5 denier and 40 denier. The inner core 35 has a first melting point, and the outer sheath 40 has a second melting point that may be different than (e.g., lower than) the first melting point. In some embodiments, the first melting point is at least 5° C. higher than the second melting point. In other embodiments, the first melting point is at least 25° C. higher than the second melting point. Accordingly, the outer sheath 40 of the staple fiber 30 will begin to melt at a lower temperature than the inner core 35 of the staple fiber 30.

As will be described in greater detail below, in the illustrated embodiment, the outer sheath 40 of the staple fiber 30 has a lower melting point than the textile yarns that were separated from the textile scrap. In other words, the outer sheaths 40 of the staple fibers 30 have melting points that are lower than the first temperature. In some embodiments, the inner core 35 of the staple fiber 30 may have a similar melting point temperature as the textile yarns. In other embodiments, the inner core 35 of the staple fibers 30 may have a higher or lower melting point temperature than the melting point temperature of the textile yarns.

Referring back to FIG. 1, the method 100 further includes the step of blending the textile yarns with the staple fibers to form a mixed blend of unprocessed textile yarns and staple fibers (step 120). For example, the textile yarns and the staple fibers may be deposited on a forming surface with a conventional carding process. The textile yarns and the staple fibers may be wet-laid or air-laid. As the components are deposited, the textile yarns and the staple fibers are mixed or otherwise dispersed with each other. The deposited textile yarns and the staple fibers may be directed through a cross lapper to help integrate the textile yarns and the staple fibers. In some embodiments, the textile yarns and the staple fibers may be mixed prior to being deposited.

In some embodiments, the mixed blend may include a greater percentage of textile yarns than staple fibers. In other embodiments, the mixed blend may include a greater percentage of staple fibers than textile yarns. In further embodiments, the mixed blend may include equal percentages of textile yarns and staple fibers. The mixed blend may have various ratios of unprocessed textile yarns to staple fibers depending on the desired properties of the panel. For example, when the mixed blend has a higher ratio of staple fibers to unprocessed textiles yarns, the resultant panel may be relatively stiffer. In other words, increasing the amount of staple fibers increases the stiffness of the panel. In some embodiments, the ratio of staple fibers to unprocessed textile yarns is 1:1. In other embodiments, a panel may include at least 50% staple fibers by weight. In further embodiments, the panel may include at least 40% staple fibers by weight. In other embodiments, the panel may include at least 60% staple fibers by weight.

After blending the unprocessed textile yarns with the staple fibers (step 120), the method 500 includes the step of heating and compressing the mixed blend to form a panel (step 125). In the illustrated embodiment, the mixed blend is heated and compressed simultaneously by heated rollers. However, in other embodiment, the mixed blend may be compressed and heated separately or at least by using separate tools that provide the compression and the heat. In some embodiments, the mixed blend may be bonded by through-air bonding, hot-oven bonding, infrared-heater bonding, or RF bonding. The duration and temperature of the bonding process is sufficiently long and high to melt the outer sheaths of the staple fibers, but not the textile yarns or the inner cores of the staple fibers.

In the illustrated embodiment, the panel is compressed into a flat panel (e.g., a wall-like structure). For example, the flat panel may be used as a privacy panel, a room separator, a backboard for posting notes, etc. In other embodiments, the panel may be compressed into a formed panel that has a non-flat shape. For example, a formed panel may be used to make portions of furniture, such as the body of a chair or the arm of a chair. Formed panels can be created by heating and compressing the mixed blend into a particular shape or form.

The mixed blend is heated at a temperature that is great enough to cause the outer sheaths of the staple fibers to melt, but low enough not to melt the textile yarns. More specifically, the mixed blend is heated at a temperature that is greater than the melting point temperature of the outer sheath of the staple fiber, but lower than the melting point temperature of the textile yarns. Heating the mixed blend at the temperature will result in the outer fiber of the staple fibers melting and binding together the other staple fibers and textile yarns of the mixed blend together to form a panel. In some embodiments, the mixed blend is heated at a temperature between 100° C. and 250° C.

After heating, the panel may be subject to one or more cooling processes and/or one or more subsequent heating processes. For example, relatively low temperature air may be passed over and/or through the panel to reduce the temperature of the panel. The panel may then be reheated (and re-cooled) as needed. In addition, the panel may be passed through one or more calendars to adjust the thickness of the panel to a desired thickness. Finally, in some embodiments, the panel may be cut to a desired size and shape. For example, the panel may be cut with an abrasive wire to achieve a clean edge. In other embodiments, the panel may be cut using other suitable cutting techniques, such as water jet, laser, oscillating knife, and the like. In addition to cutting the panel into a desired shape, the panel may have cut out portions, which may be adapted for different purposes. For example, a cut-out may be created to receive hardware designed to support a panel in an upright position, to increase stiffness, or to couple multiple panels together. The panel may also include recesses formed or cut into the panel to receive excess fabric material (i.e., layer of fabric). The panel may also be bent into a desired curvature rather than remaining a flat panel.

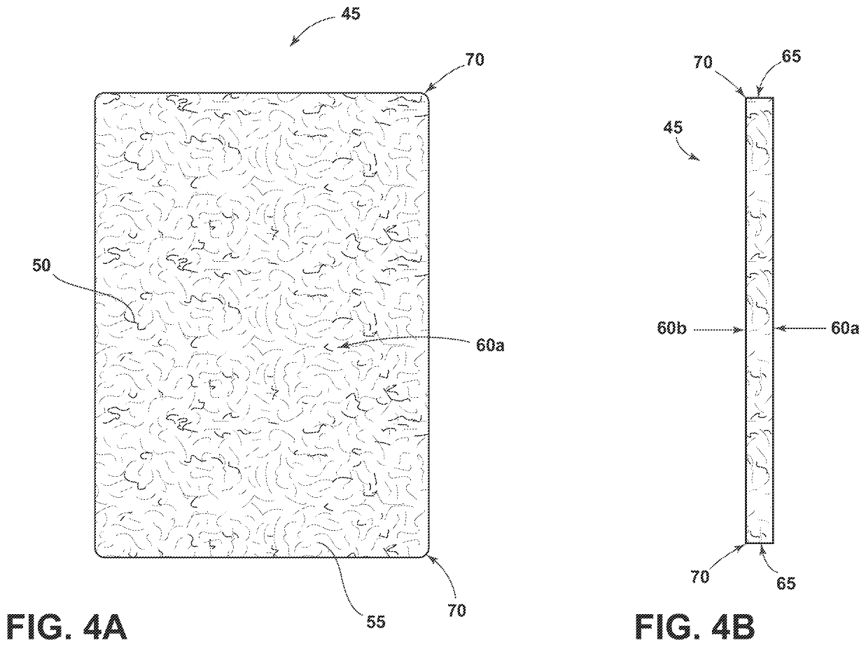

FIGS. 4A & 4B illustrate a panel 45 manufactured using the method 100. FIG. 4A illustrates the panel 45 from a perspective view, while FIG. 4B illustrates the panel 45 from a side plan view. The illustrated panel 45 is generally rectangular. In particular, the illustrated panel 45 includes first and second opposed sides (or faces) 60a, 60b and an edge 65 extending around the perimeter of the sides 60. Additionally, the panel 45 includes a plurality of corners 70. The corners 70 may be square corners (i.e., roughly 90 degree corners) or radius corners (i.e., rounded corners). However, in other embodiments, the panel 45 may have other shapes.

The panel 45 consists essentially of a plurality of textile yarns 405 from textile scraps and a plurality of staples fibers 55. The textile yarns 405 and the staple fibers 55 are blended and bonded together to form the panel 45 as a monolithic structure. The panel 45 may be generally self-supporting, in that the panel 45 can stand on one of its edges without bending over. In some embodiments, the panel 45 may have a length or height of up to, for example, 72 inches. In some embodiments, the length or height may be between about 6 inches and about 72 inches. The panel 45 may also have a thickness between 0.05 inches and 1.5 inches. In some embodiments, the thickness may be less than 1.5 inches. In other embodiments, the thickness may be greater than 1.5 inches. In addition, the panel 45 may have a density between 500 grams per square meter (gsm) and 2500 gsm. In some embodiments, the panel 45 may be bent or curved into a desired shape to fit on furniture or other items. As such, the panel 45 may have a bend radius between 1.5 mm and 300 mm, depending on the thickness of the panel 45.

In some embodiments, the panel 45 has a variety of different colors and textures. For example, in situations where multiple textiles are used having different colors and textures, the chunks of textile yarns will mesh together to form a panel with different colors and textures. For example, the panel 45 may have a spotted or a marbled look from the various textile yarns and staple fibers.

Since the panel 45 is composed (mostly) of polymer (e.g., polymer from textile scrap and polymer from staple fibers), the panel 45 itself may be recycled. For example, in some embodiments, the panel 45 may be mechanically separated and used as the textile scrap in the method 100 (FIG. 1). In embodiments where two panels 45 are coupled together, the two panels 45 may be glued together with a polymer-based adhesive such that the combined panels 45 are still composed mostly of polymer.

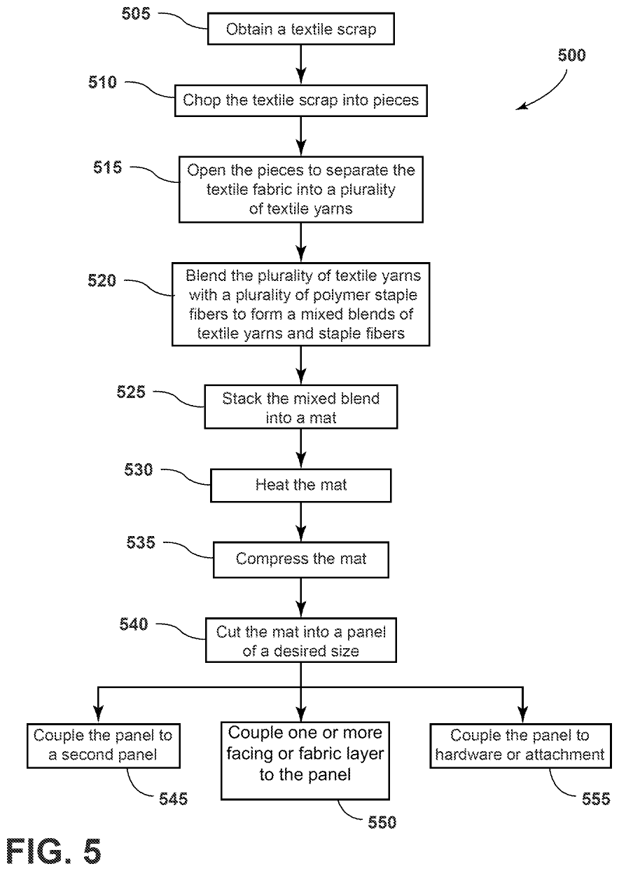

FIG. 5 illustrates another method 500 of manufacturing a panel (identified generally as 150), or a screen. As used herein, the term “a naked panel” refers to a panel alone (i.e., without addition elements). The term “screen” may refer to a panel including additional elements, such as facings, fabric coverings, hardware, and the like, which may be used to finish the panel so that it may be used as a screen. The term “a panel” may refer to a naked panel or a panel including additional elements, such as facings, fabric coverings, hardware, etc. The method 500 is similar to the method 100 described above, and like steps may be performed in the same way. Reference is made to the description of the steps of method 100 for details of the steps of method 500 not included below. The method 500 does not need to include all of the illustrated steps or need to perform the steps in the order listed.

The illustrated method 500 includes steps of obtaining a textile scrap (step 505), chopping the textile scrap into pieces (step 510), and opening the pieces to separate the textile fabric into a plurality of textile yarns (step 515). The opening step 515 may be performed by pulling apart or combing the pieces of textile scrap. The method 500 also includes the steps of blending the plurality of textile yarns with a plurality of polymer staple fibers to form a mixed blend of textile yarns and staple fibers (step 520), stacking the mixed blend into a mat (step 525), heating the mat (step 530), compressing the mat (step 535), and cutting the mat into a panel 150 of a desired size and shape (step 540). For example, the panel 150 may be cut with an abrasive wire to achieve a clean edge. In other embodiments, the panel 150 may be cut using other suitable cutting techniques, such as water jet, laser, oscillating knife, and the like. In addition to cutting the panel 150 into a desired shape, the panel 150 may have cut out portions, which may be adapted for different purposes. For example, a cut-out may be created to receive hardware designed to support a panel 150 in an upright position, to increase stiffness, or to couple multiple panels 150 together. In some embodiments, the cut-outs may be formed by compressing sections of the panel 150, rather than removing material from the panel 150. The panel 150 may also be bent into a desired curvature rather than remaining a flat panel 150.

As will be described in further detail below, after the panel 150 is cut to the desired size (step 540), the naked panel 150 may be finished (steps 545, 550, 555) in a variety of ways to form a screen 245. The term “naked panel” refers to a panel 150 formed of textile yarns and polymer staple fibers, which is formed into a panel 150 or cut to a desired shape, as described in methods 100 or 500. The naked panel 150 may then be finalized during the finishing process (steps 545, 550, 555) to ultimately form a screen 245. The finishing process may include coupling the panel 150 to a second panel 150 (step 545), coupling one or more facings (identified generally as 155) to the panel 150 (step 550), and/or coupling the panel 150 to hardware or an attachment (e.g., a frame, a hanging member, a stand, etc.) (step 555). As will be understood, the method 500 may include one or more of the finishing steps (steps 545, 550, 555), which may be completed in any order. Alternatively, the method 500 may not include any finishing steps (steps 545, 550, 555), but rather may leave the panel 150 naked. It should be understood that the finishing steps (steps 545, 550, 555) may be applicable to either method 100 or method 500.

Furthermore, the finishing steps (steps 545, 550, 555) described herein may be done prior to completing the naked panel 150, or during the process of manufacturing the naked panel 150. For example, in some embodiments, two or more panels 150 may be coupled together (step 545) during or before any of the other steps described in the method 500 (e.g., steps 530-540). Likewise, one or more facing 155 may be coupled to the panel 150 (step 550) during or before any of the other steps described in the method (e.g., steps 530-540). For example, a polyester-based adhesive may be used to couple a facing 155 to the panel 150 during steps 530 or 535, while the mat (i.e., the panel 150) is being heated and compressed. Additionally, one or more hardware or attachments may be coupled to the panel 155 during or before any of the other steps described in the method (e.g., steps 530-540).

In one finishing step (step 545), two panels 150 may be coupled together. Coupling the two panels 150 together may increase the overall stiffness of the panels 150. In addition, coupling the two panels 150 together allows other elements to be positioned or tucked between the panels 150. For example, if either or both of the panels 150 are wrapped in fabric, edges of the fabric may be tucked between the two panels 150. Likewise, support structures (e.g., rods, etc.) may be positioned between the panels 150 to increase the strength and stiffness of the panels 150. Additionally, other hardware may be supported and/or partially hidden between two panels 150. Hanging hardware or a support stand may be coupled between two panels 150 to help hold the panel(s) in an upright position or a hanging position.

The panels 150 may be coupled together using a variety of different processes. For example, the panels 150 may be bonded together through RF bonding, ultrasonic bonding, or IR bonding. Furthermore, the panels 150 may be coupled together using a mechanical coupling. Such a mechanical coupling may itself be hidden between the two panels 150 once the panels 150 are coupled together.

In some embodiments, the panel 150 may be covered by one or more facings 155 (i.e., a layer, a covering, or a partial covering) to create a desired visual appearance or to achieve a desired structural characteristic (step 550). In other words, a facing 155 made of a different material may be coupled to or wrapped around at least a portion of the panel 150 to improve the appearance of the panel 150 or provide a functional enhancement to the panel 150.

A facing 155 may be arranged on the panel 150 in a variety of different manners. A facing 155 may cover the entire panel 150 or may wrap around only a portion of the panel 150. For example, in some embodiments, a facing 155 may be wrapped around the sides of the panel 150 as well as around the edge. In other embodiments, a facing 155 may only extend across a side of the panel, but may not be wrapped around the edge of the panel 150. Contrarily, in other embodiments, facing 155 may only be wrapped around the edge of the panel, but may not extend across a side of the panel 150. In yet another embodiment, a facing 155 may be wrapped around the edge of the panel 150 and only a single side.

Furthermore, a single facing 155 may be used or multiple separate facings 155 may be used. In some embodiments, multiple facings 155 may be used on different portions of the panel 150. For example, a first facing 155 may be wrapped around the edge of the panel 150 while a second facing 155 may be coupled to a side of the panel 150. Similarly, in some embodiments, there may be more than one layer of facings 155 covering a portion of the panel 150. For example, a first facing 155 may be coupled to the panel 150, and a second facing 155 may overlay the first facing 155 to create a two layers of facings 155. Additionally, when multiple facings 155 are used on a single panel 150, each facing 155 may be composed of a different material or have different characteristics, such as texture, stiffness, strength, or visual appearance. In some embodiments, a first facing 155 may be used to enhance the structure of the panel 150 and a second facing 155 may be wrapped around the first facing 155 to enhance the visual appearance of the panel 150. For example, the first facing 155 may increase rigidity of the panel 150 and provide sharp edges around the perimeter of the panel 150. The second facing 155, such as a fabric layer, may be wrapped around the first facing 155 to achieve a desired look.

As mentioned, the facing 155 may be used to improve the structural integrity of the panel 150 by, for example, adding rigidity or strength to the panel 150. In some embodiments, the facing 155 may be composed of a material having greater rigidity or strength than the naked panel 150 in order to increase the overall rigidity and strength of the panel 150. In other embodiments, the facing 155 may not have greater rigidity and strength than the naked panel, however, the facing 155 may increase rigidity and strength simply by adding additional layers to the panel 150. Furthermore, in some embodiments, a facing 155 may be coupled to the panel 150 around the edges in order to increase the strength of the panel 150 along the edges.

In some embodiments, the facing 155 may be used to improve the smoothness of any side or edge of the panel 150. For example, because the naked panel 150 is formed by mixing scraps of material together that are melted and/or pressed together, the panel 150 may have some uneven or bumpy texture. The facing 155 may have a smoother texture than the naked panel 150 and may be coupled to the side and/or edge of the panel 150 to increase the smoothness of the panel 150. Similarly, the facing 155 may be used to inhibit warping or unintended curvature of the panel 150.

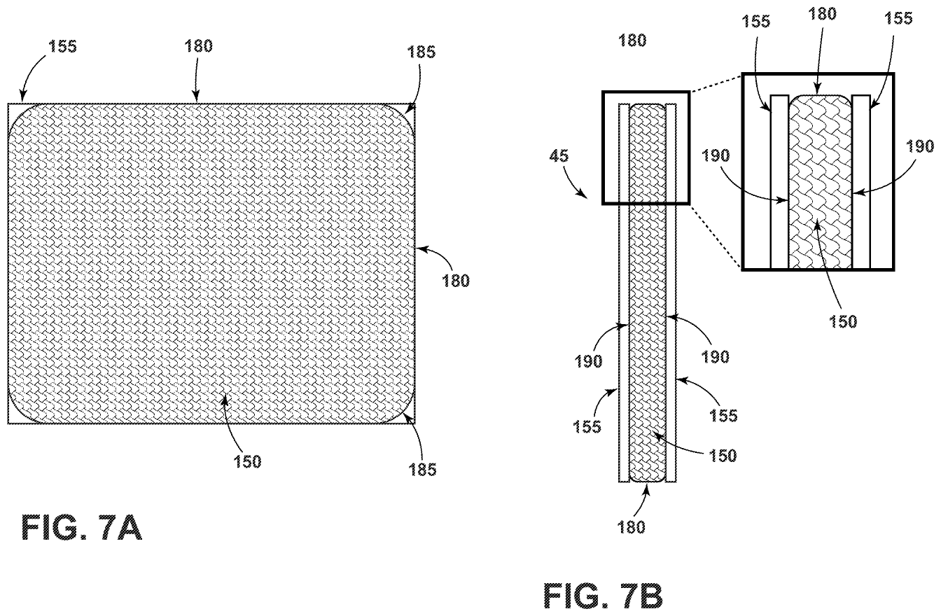

Furthermore, in some embodiments, the facing 155 helps to create sharp edges and/or corners by reducing the rounding of corners and edges. More specifically, as shown schematically in FIGS. 7A and 7B, the naked panel 150 may not have extremely straight, or sharp edges 180 and corners 185 (i.e., squared or 90 degree edges and corners). Rather, during the manufacturing process of the panel 150, the edges 180 or corners 185 may unintentionally become rounded or warped. Accordingly, a facing 155 may be used to create sharper edges 180 and corners 185. In some embodiments, a facing 155 may be coupled to the sides 190 of the panel 150 in order to create the sharp edges 180 and sharp corners 185. Alternatively, the facing 155 may be coupled to the edge 180 of the panel 150 in order to create a sharp edge 180 or a sharp corner 185. Further, in other embodiments, the facing 155 may be coupled to both the edge 180 and the side 190 of the panel 150. In this embodiment, the facing 155 may include a single facing 155 that is wrapped around the edge 180 and the sides 190 of the panel 150, or may include multiple separate facings 155. For example, one facing 155 may be positioned around the edge 180 of the panel 150 and separate facings 155 may be positioned on each side 190 of the panel 150.

The facings 155 may include a variety of different types of materials. In some embodiments, the facing 155 may include a paper-like material. In other embodiments, the facing 155 may include a non-woven scrim. For example, a facing 155 may be composed of a paper-like material, such as craft paper, resin impregnated paper, multi-layer resin-impregnated paper, or polyethylene lined paper. The facing 155 may be composed of a type of polymer based material such as, polyester, polypropylene, spunbond polyester or point bond polyester. The facing 155 may be composed of other materials such as aluminum foil, fiberglass, veneer, or a PET film. The facings 155 may also include a variety of different fabrics or decorative features to achieve a desired visual appearance. In some embodiments, the facings 155 may be composed essentially of polymer such that the entire panel 150 (including the facings 155) may be recycled. For example, the panel 150 and facings 155 may be recycled and used to create additional panels 150 as described herein in methods 100 and 500.

In some embodiments, the panel 150 includes the same facings 155 on each side or side of the panel 150, while in other embodiments, each side or side of the panel 150 may have a different facing 155 or series of facings 155. In some embodiments, only one side of the panel 150 may include one or more facing 155, while the other side of the panel 150 remains naked. Furthermore, the facings 155 may be double sided or single sided. Also, as previously mentioned, the facings 155 may be layered together to achieve a desired structure and/or visual appearance. In some embodiments, the panel 150 may include an additive to give the panel 150 fire resistant or fire-retardant properties. The additive may include, for example, other staple fibers, a spray, a powder, and the like.

Additionally, the facings 155 may be coupled to the panel 150 by a variety of different adhesives and/or mechanical coupling members. Likewise, two or more panels 150 may be coupled together by a variety of adhesives and or mechanical coupling members. For example, the following adhesives may be used to adhere a facing 155 to a panel 150 or two panels 150 together: web adhesive, liquid glue such as Seal Bond, caulk gun/pneumatic, hot melt (e.g., polyurethane), tape, pressure sensitive tape (PSA), or powder adhesives. Alternatively or additionally, a mechanical fastener may be used to coupled the facings 155 to the panel 150 or two panels 150 together. Mechanical facings 155 may include staples, nails, thread, pins, or other mechanical fasteners.

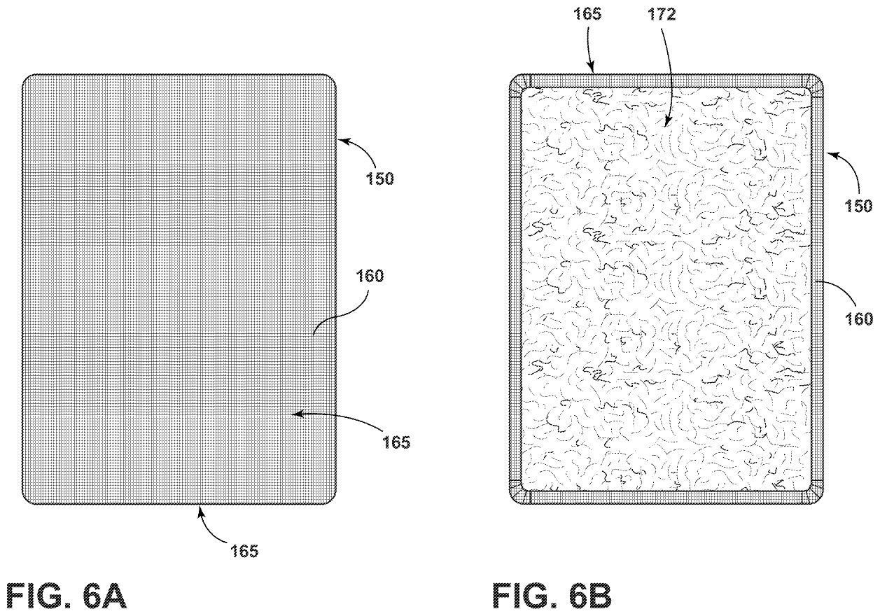

In addition to or alternatively to coupling a facing 155 to the panel 150, a fabric layer 225 may be coupled to the panel 150. In some embodiments, a layer of fabric 160 may be wrapped around the facings 155 to provide a desired aesthetic look. In other embodiments, the layer of fabric 160 may be coupled directly to the panel 150 without a facing 155 in between. The layer of fabric 160 may be wrapped around the entire panel 150 or may be wrapped around only a portion of the panel 150. In some embodiments, a layer of fabric 160 may be wrapped around a first side of the panel 150 while leaving a second side of the panel 150 naked or covered with a facing 155. This arrangement may be particularly useful in situations where two panels 150 are coupled together. For example, referring to FIGS. 6A and 6B, the layer of fabric 160 covers a front side 165 of the panel 150 (i.e., an outwardly facing side or the panel) and the edges 170 of the panel 150. In the illustrated embodiment, the layer of fabric 160 only covers a small portion of the rear side 175 of the panel 150 (i.e., an inwardly facing side of the panel) such that the majority of the rear side 175 the panel 150 remains naked. This arrangement of the layer of fabric 160 enables the edges of the layer of fabric 160 to be concealed between the two panels 150 once they are coupled together. Specifically, a second panel 150 may be prepared in a similar manner. The panels 150 may then be arranged with the naked (or primarily naked) rear sides 175 positioned inwardly and being coupled together.

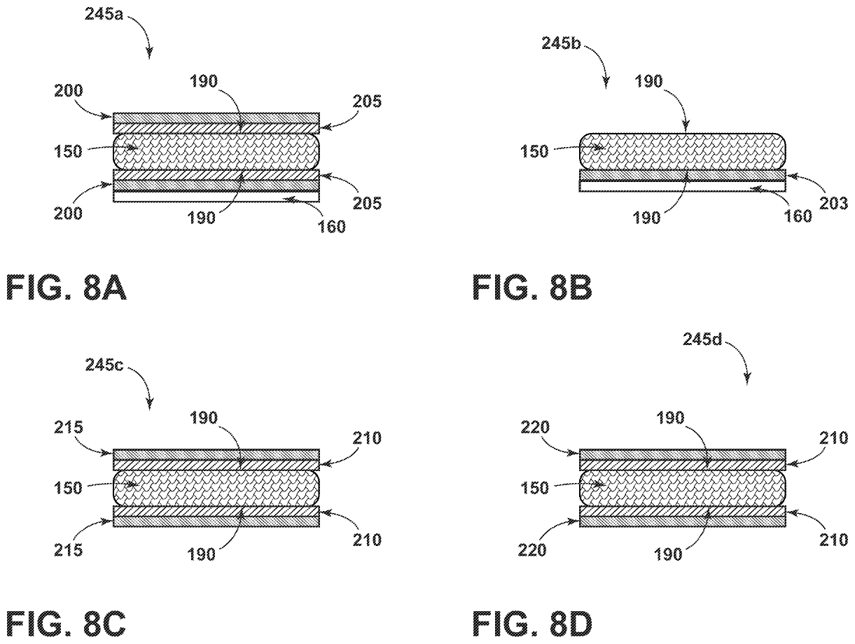

FIGS. 8A-8D schematically illustrate some exemplary embodiments of a screen 245. These examples are for illustrative purposes and are not intended to be limiting. The screen 245 illustrated in FIG. 8A includes a naked panel 150 including a facing 155 composed of layer of paper 200, such as resin-impregnated paper, on each side 190 of the panel 155. The paper 200 is adhered to the panel 150 by a polymer, such as a polyester web adhesive 205. The panel 150 further includes a layer of fabric 225 on one side.

The panel 150 illustrated in FIG. 8B includes a naked panel 150 including a facing 155 composed of a non-woven scrim 203 on one side 190 of the panel 150. Additionally, the panel 150 includes a layer of fabric 225 covering the non-woven scrim 203. In this embodiment, the opposite side of the panel 150 remains naked.

FIG. 8C illustrates a panel 150 composed of a naked panel 150 surrounded by a first facing 155 composed of a layer of polyamide film 210 on each side 190, followed by a second facing 155 composed of a layer of spunbond scrim 215 on each side 190.

FIG. 8D illustrates a panel 150 including a naked panel 150 including a facing 155 composed of a layer of polyamide film 210 on each side 190, followed by a second facing composed of a pointbond scrim 220 on each side 190. As previously mentioned, the panels 150 may not include the same facings 155 on each side of the panel 150. For example, in some embodiments, a panel 150 may have additional or different facings 155 on one side of the panel 150 than the opposed side of the panel 150. Additionally, any of the panels 150 shown in FIGS. 8A-8D may further include a layer of fabric surrounding the facings 155 shown.

Finally, the panel 150 may be coupled to one or more piece of hardware or attachments (step 555). For example, the panel 150 may be coupled to (e.g., positioned within) a frame that partially or fully surrounds an outer edge of the panel 150. Alternatively, the panel 150 may be coupled to a hanging member (e.g., hook, clip, etc.) to hang the panel 150 from an overhead structure, such as a ceiling or beam. Alternatively, the panel 150 may be coupled to a stand to support the panel 150. The stand may include wheels to move the panel 150 within a room or may be stationary within the room. In some embodiments, the panel 150 may be coupled to multiple attachments (e.g., a frame and a hanging member). Additionally, the panel 150 may include hardware to help secure a facing 155 to the panel 150 or to help couple two panels 150 together. For example, as described in further detail herein, a piece of hardware may be used to receive and conceal excess fabric from a layer of fabric 155.

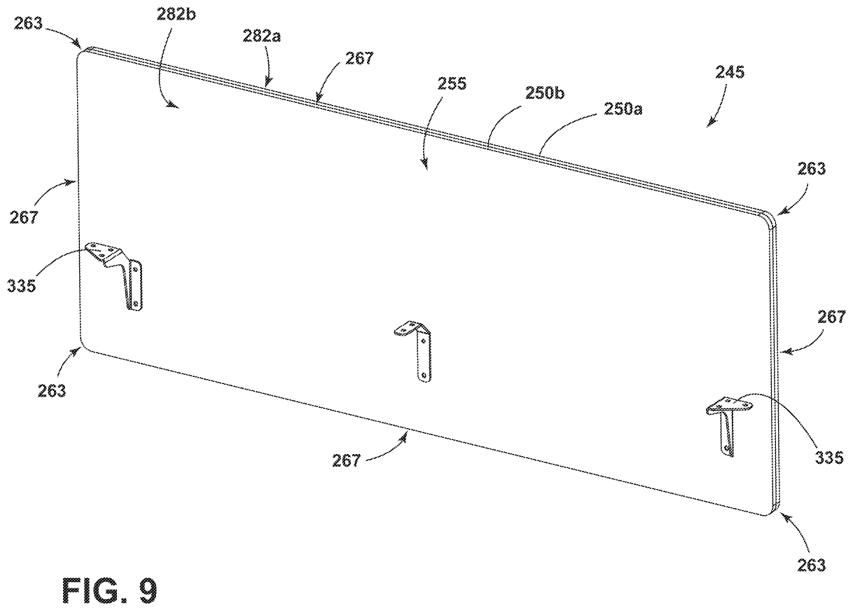

FIGS. 9-18 illustrate an exemplary screen 245 finished according to some of the finishing steps (steps 545, 550, 555) described herein. The illustrated screen 245 is formed from two individual panels 250a, 250b that are coupled together. When multiple panels 250a, 250b are coupled together, the screen 245 may also be referred to as a screen assembly. As previously mentioned, this may be done to increase stiffness and stability, or to make it easier to wrap the panels 250a, 250b in a layer of fabric 255 and hide the ends or folds of the layer of fabric 255 between the two panels 250a, 250b. Each panel 250a, 250b is formed of textile scraps and staple fibers, as described with respect to methods 100 and 500. The panels 250a, 250b each have a first side 280a, 280b and a second side 282a, 282b opposite the first sides 280a, 280b, respectively. When the panels 250a, 250b are coupled together the first sides 280a, 280b will be inwardly facing and will be coupled together. The second sides 282a, 282b will be outwardly facing.

Before coupling the panels 250a, 250b together, each panel 250a, 250b is prepped as follows. The below description is described with respect to the first panel 250a, however, it should be understood that the second panel 250b may be prepared in a similar fashion. The first and second panels 250a, 250b may then be coupled to together to complete the assembly of the screen 245.

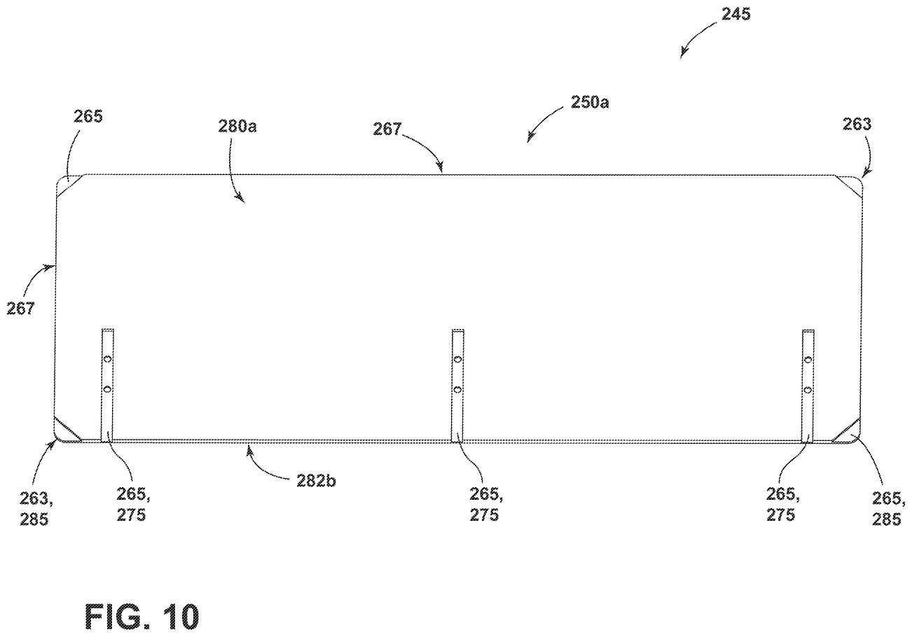

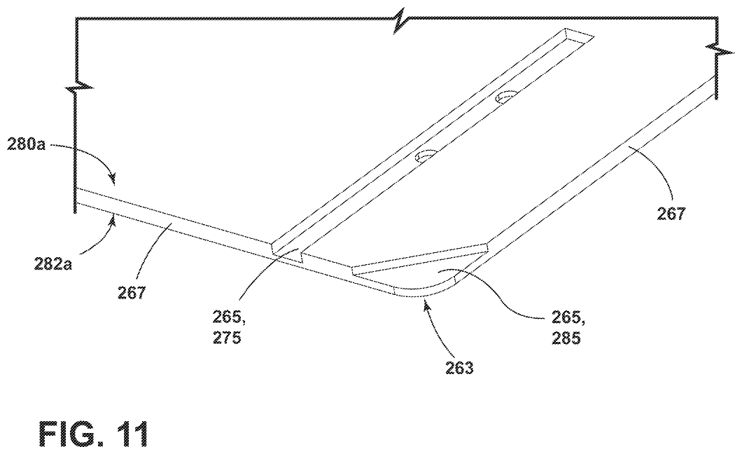

Referring to FIGS. 10-11, the panel 250a is cut to the desired size and shape. The illustrated panel 250a is a generally rectangular panel 250a with rounded corners 263, or radius corners 263. However, in other embodiments, the panel 250a may be cut into other shapes. Additionally, a plurality of cutouts or recesses 265 are formed (e.g., cut, compressed, etc.) in the panel 250a to accommodate various hardware 270. In the illustrated embodiment, the cutouts 265 are formed into the first side 280a of the panel 250a. As previously mentioned, when the overall screen 245 construction is complete, the first side 280a of the first panel 250a will be inwardly facing and will be coupled to the first side 280b of the second panel 250b.

One or more facing 155, such as the facings illustrated in FIGS. 8A-8D, may be coupled to the panel 250a. Specifically, one or more facings 155 may be coupled to one or both sides 280a, 282a of the panel 250a. The one or more facings 155 may be coupled to the panel 250a at different stages in the process. For example, a facing 155 may be coupled to the panel 250a after the panel 250a is cut to the desired size and shape. Alternatively, the facing 155 may be coupled to the panel 250a prior to cutting the panel 250a to size and shape so that the facing 155 is cut together with the panel 250a.

Furthermore, in some embodiments, multiple facings 155 may be coupled the panel 250a at different times during the process of finishing the overall panel 250a construction. For example, in one embodiment, a first facing 155 is coupled to the panel 250a prior to the panel 250a being cut to size and shape or prior to the cutouts 265 being formed. The first facing 155 may be a facing 155 adapted to improve a structural characteristic of the panel 250a, such as increasing the stiffness of the panel 250a. In this embodiment, a second facing 155 may be coupled to the panel 250a at a later stage in the process. For example, a second facing 155or a layer of fabric 255 may be coupled to the panel 250a after the cutouts 265 are formed and after hardware 270 is installed on the panel 250a.

Additionally, a layer of fabric 255 may be wrapped at least partially around the panel 250a. Specifically, one or more layer of fabric 255 may be coupled to one or both sides 280a, 282a of the panel 250a. The one or more layer of fabric 255 may be coupled to the panel 250a at different stages in the process. For example, a layer of fabric 255 may be coupled to the panel 250a after the panel 250a is cut to the desired size and shape. Alternatively, the layer of fabric 255 may be coupled to the panel 250a prior to cutting the panel 250a to size and shape so that the layer of fabric 255 is cut together with the panel 250a. Furthermore, in some embodiments, multiple layer of fabric 255 may be coupled the panel 250a at different times during the process of finishing the overall panel 250a construction.

In the illustrated embodiment, the cutouts 265 include elongated channels 275, which are formed in a first side 280a of the panel 250a. The channels 275 are sized and shaped to receive brackets 295. In the illustrated embodiment, the panel 250a includes three channels 275, however, in other embodiments, a greater or fewer number of channels 275 may be formed in the naked panel 250a. Additionally, corner cutouts or recesses 285 are formed in the naked panel 250a. The corner cutouts 285 are sized and shaped to receive additional hardware 270, such as corner mounts 290, which may be used to secure a layer of fabric 255 to the panel 250a. The corner mounts 290 may also be used to align and/or coupled the panel 250a to a second panel 250b. In the illustrated embodiment, the corner cutouts 285 create recessed corners 263.

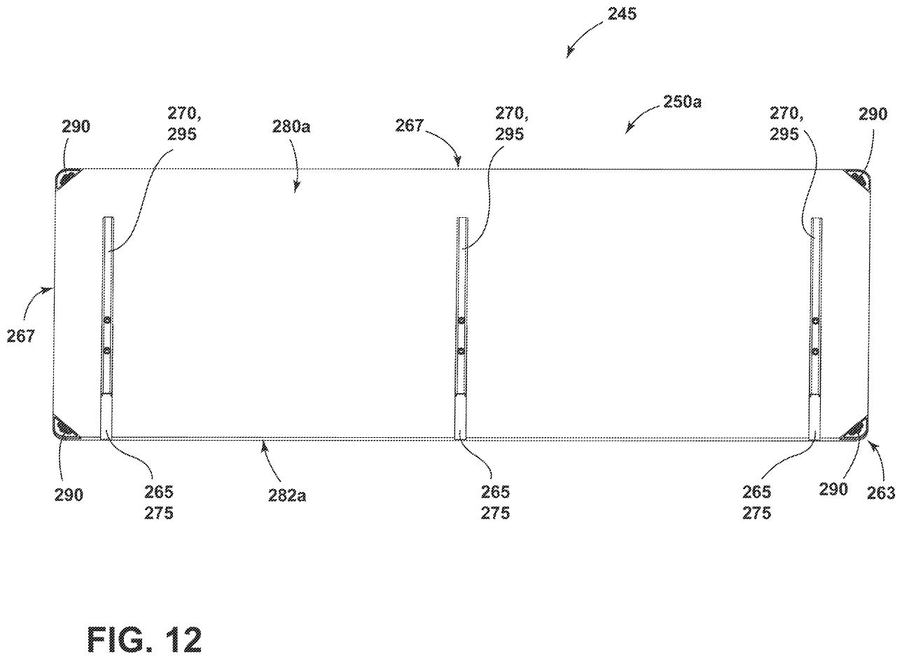

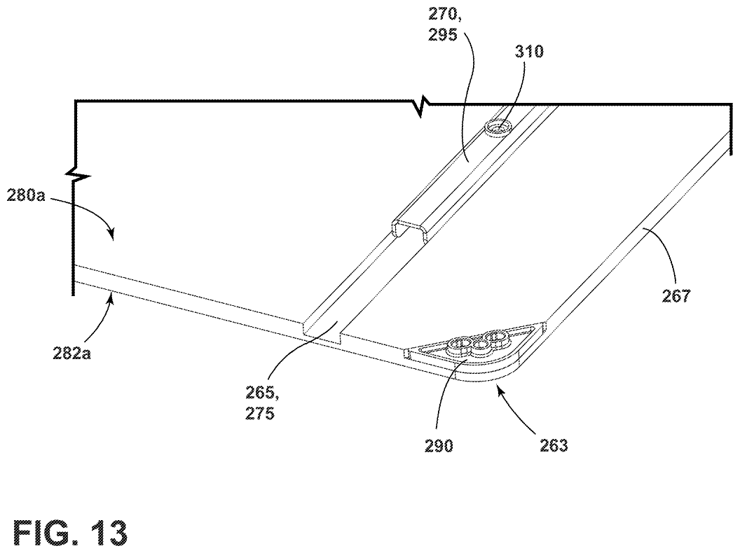

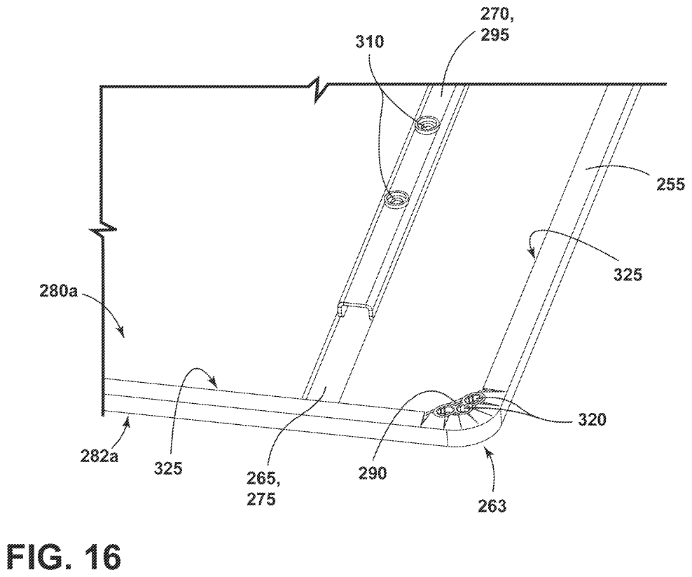

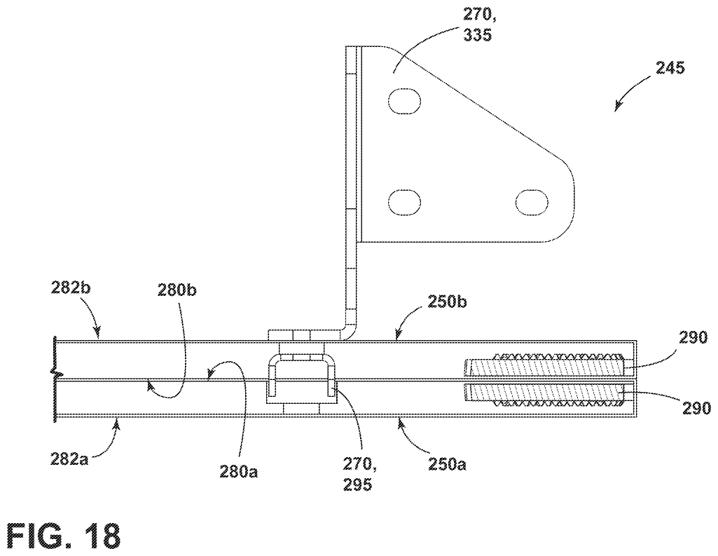

Referring to FIGS. 12-13, the hardware 270 is placed within the cutouts 265 of the panel 250a. In the illustrated embodiment, U-shaped brackets 295 are placed within the channels 275. However, other types of brackets 295 may be used. The brackets 295 are adapted to be coupled to hanging hardware 335 or a stand to support the panel 250 in an upright position. Referring to FIGS. 9 and 18, the brackets 295 will eventually be coupled to hanging hardware 335, which may be used to support the panel 250. To that end, the brackets 295 include holes 310 (FIGS. 13 and 16) for receiving fasteners, and the like.

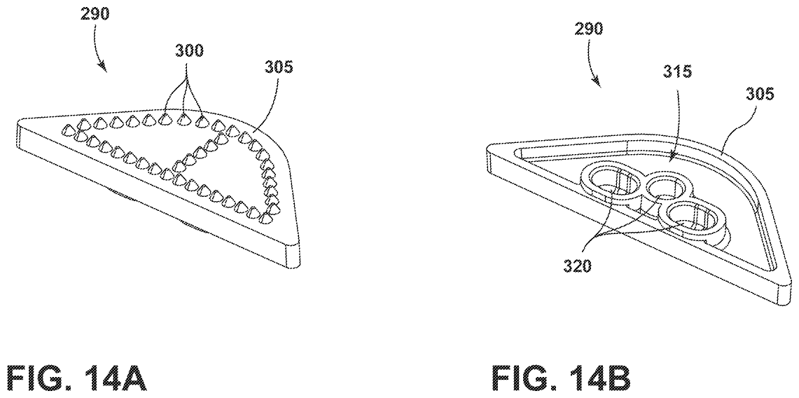

In addition, corner mounts 290 are placed within the recessed corners (i.e., the corner cutouts 285) of the panel 250a. FIGS. 14A-14B illustrate one embodiment of a corner mount 290. The corner mounts 290 may be made of plastic, metal, or other rigid material. The illustrated corner mounts 290 are generally triangular shaped with a radius corner 305 that aligns with the radius corner 263 of the panel 250a. In other embodiments, the corner mount 290 may have a right angle or other shape based on the shape of the panel 250a. The illustrated corner mounts 290 include a plurality of cleats 300 to help position and maintain the corner mounts 290 within the corner cutouts 285. In particular, the creates create grip/friction between the corner mount 290 and the corner cutout 285 to inhibit movement and slippage of the corner mounts 290.

The corner mounts 290 may be added to the panel 250a to help maintain and reinforce the shape of the corner 263. The corner mounts 290 may also help create a sharp corner 263 and/or edge 267 and inhibit warping. Furthermore, the corner mounts 290 may assist with wrapping the panel 250a in a layer of fabric 255. For example, in the illustrated embodiment, the corner mounts 290 may receive the excess fabric from the layer of fabric 255 that occurs around the corners 263 of the panel 250a. To this end, corner mounts 290 include recesses 315 for receiving the excess fabric from the layer of fabric 255.

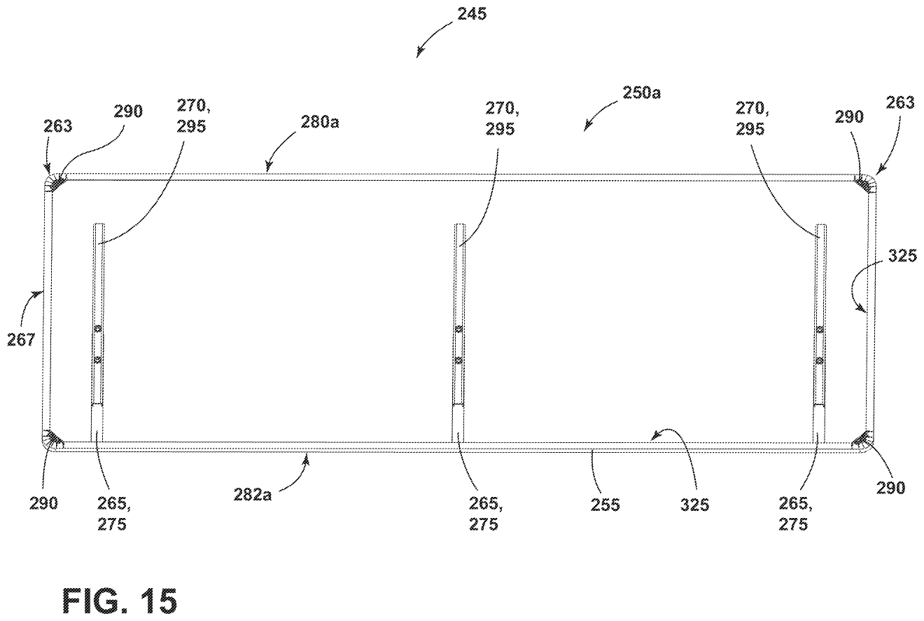

Referring to FIGS. 15-16, the panel 250a is partially wrapped in a layer of fabric 255 to cover the second side 282a of the panel 250a. Specifically, a layer of fabric 255 is wrapped around the side 282a of the panel 250a which will ultimately be outwardly facing after the overall panel 250 construction is complete. To assist in wrapping of the layer of fabric 255, the fabric may be cut into a pattern that reduces the overall amount of fabric to be tucked into the corner mounts 290. As shown in the illustrated embodiment, the triangular portions of the fabric corners 263 are cut out to reduce the overall amount of fabric that is gathered around the corners 263. Regardless, the excess fabric that from the layer of fabric 255 is received within a recess 315 of the corner mount 305.

Furthermore, the corner mounts 290 may also be used to help align the two panels 250a, 250b (i.e., the two panels halves) when the panels 250a, 250b are coupled together. For example, as shown in FIGS. 14A and 14B, the corner mounts 290 include circular alignment members 320, which mate with or at least align with alignment members 320 on a corresponding corner mount 290 on the second panel 250b. In some embodiments, the corner mounts 290 may snap together in order to couple the two panels 250a, 250b together. While in other embodiments, the corner mounts 290 only align the panels 250a, 250b, but do not snap together. In either case, the panels 250a, 250b may be secured together by either a bonding adhesive, heat treatment, pressing process, etc., as described herein.

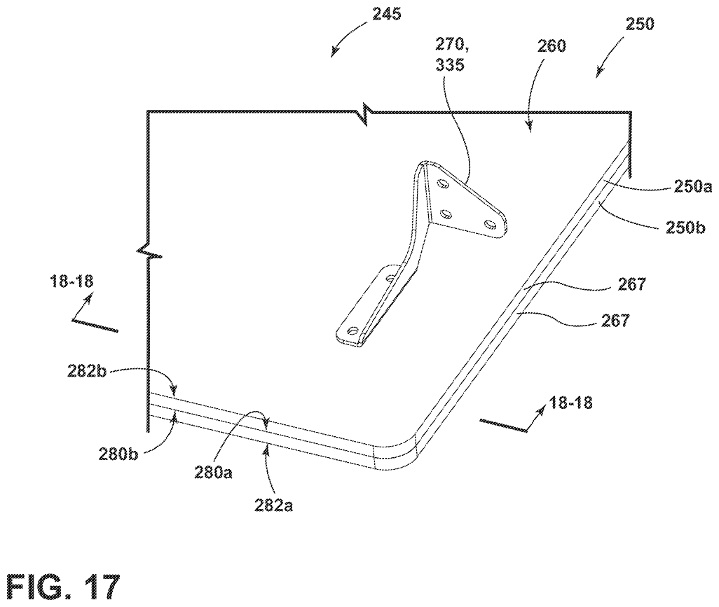

FIGS. 9, 17, and 18 illustrate the panels 250a, 250b after being coupled together (step 545) to form a completed panel 250 construction. As discussed above, each panel 250a, 250b is coupled to one or more facings 155 or layer of fabrics 255 (step 550), and each panel 250a, 250b is finished with cutouts 265 and hardware 270 (step 555). The two panels 250a, 250b are then coupled together (step 545) to form a completed panel construction (also referred to as a screen assembly). In the illustrated embodiment, the panels 250a, 250b are arranged with the cutouts 265 and hardware 270 positioned on an inwardly facing sides 280a, 280b in order to at least partially conceal the cutouts 265 and hardware 270. The layer of fabric 255 is wrapped around the sides 282a, 282b of the panels 250a, 250b, which will be arranged on the outside of the completed panel 250 construction. Notably, the edges 325 of the layer of fabric 255 are positioned on the inwardly facing sides 280a, 280b of the panels 250a, 250b to hide the edges 325 of the layer of fabric 255 and create a clean, finished look. Referring to FIGS. 9 and 17, one or more hanging hardware 270 is coupled to the panel 250 to support the panel 250 in an upright configuration. Specifically, the hanging hardware 335 is coupled to the concealed bracket 295, as shown in FIG. 18.

The embodiments described above and illustrated in the figures are presented by way of example only and are not intended as a limitation upon the concepts and principles of the present disclosure. As such, it will be appreciated that various changes in the elements and their configuration and arrangement are possible without departing from the spirit and scope of the present disclosure. Various features and advantages of the disclosure are set forth in the following claims.

What is claimed is:

1. A method of manufacturing a panel, the method comprising:
obtaining a textile scrap, the textile scrap consisting essentially of polyester;
mechanically separating the textile scrap into a plurality of textile yarns, each of the plurality of textile yarns having a first melting point that is greater than a first temperature;
obtaining a plurality of staple fibers, the plurality of staple fibers including bicomponent fibers each having a melting point that is less than the first temperature;
blending the plurality of textile yarns with the plurality of staple fibers to form a mixed blend of textile yarns and staple fibers; and
heating and compressing the mixed blend to form the panel.

2. The method of claim 1, wherein the textile scrap is a woven textile scrap.

3. The method of claim 2, wherein the textile scrap includes both warp yarns and weft yarns.

4. The method of claim 1, wherein obtaining the textile scrap includes obtaining the textile scrap from excess furniture upholstery.

5. The method of claim 1, wherein the plurality of textile yarns is non-homogenous.

6. The method of claim 5, wherein the plurality of textile yarns includes one or more of the following: yarns of varying denier, yarns of varying lengths, yarns of varying textures, and yarns of varying color.

7. The method of claim 1, wherein mechanically separating the textile scrap includes cutting the textile scrap into pieces and pulling apart the pieces into the plurality of textile yarns.

8. The method of claim 1, wherein blending the plurality of textile yarns with the plurality of staple fibers includes blending a greater proportion of staple fibers than textile yarns to form the mixed blend.

9. The method of claim 1, further comprising stacking the mixed blend into a mat prior to heating and compressing.

10. The method of claim 1, wherein the panel is a first panel, and wherein the method further comprises coupling the first panel to a second panel.

11. The method of claim 10, wherein coupling the first panel to the second panel includes coupling a first mount to the first panel and a second mount the second panel, and aligning the first panel and the second panel by aligning the first mount and the second mount.

12. The method of claim 1, further comprising covering at least a portion of the panel with a facing.

13. The method of claim 12, further comprising coupling a corner mount to a corner of the panel, and wrapping excess facing into a recess formed in the corner mount.

14. The method of claim 1, further comprising coupling the panel to an attachment selected from a group consisting of a frame, a hanging member, and a stand.

15. The method of claim 1, wherein the plurality of staple fibers includes polyester staple fibers, polypropylene staple fibers, or both.

16. A screen comprising:
a panel consisting essentially of:
a plurality of polyester textile yarns from a textile scrap, the plurality of polyester textile yarns being non-homogeneous and having a first melting point that is greater than a first temperature, and
a plurality of staple fibers, the plurality of staple fibers being homogeneous and having a melting point that is less than the first temperature,
wherein the plurality of polyester textile yarns and the plurality of staple fibers are blended and bonded together.

17. The screen of claim 16, further comprising a first facing coupled to a first side of the panel.

18. The screen of claim 17, wherein the first facing is selected from a group consisting of a paper and a non-woven scrim.

19. The screen of claim 17, wherein the first facing is bonded to the panel by a polyester-based adhesive

20. The screen of claim 17, further comprising a fabric layer covering at least the first facing and the first side of the panel.

21. The screen of claim 20, further comprising a corner mount positioned at a corner of the panel on a second side of the panel, the corner mount including a recess configured to receive excess fabric from the fabric layer that is wrapped around the panel.

22. The screen of claim 17, further comprising a second facing coupled to a second side of the panel opposite from the first side.

23. The screen of claim 16, further comprising an attachment coupled to the panel to support the panel in an upright manner, wherein the attachment is selected from a group consisting of a frame, a hanging member, and a stand.

24. The screen of claim 23, wherein the panel includes a recess that receives the attachment.

25. The screen of claim 24, wherein the recess is positioned proximate a corner of the panel.

26. The screen of claim 24, wherein the recess is positioned in a middle section of the panel.

27. The screen of claim 16, wherein the plurality of staple fibers includes polyester staple fibers, polypropylene staple fibers, or both.

28. A screen assembly, comprising:
a first panel including a first side, a second side, and an edge extending around a perimeter of the first and second sides;
a second panel coupled to the first panel, the second panel including a first side, a second side, and an edge extending around a perimeter of the first and second sides, wherein the first side of the second panel faces the first side of the first panel;
a first fabric layer extending around the second side of the first panel;
a second fabric layer extending around the second side of the second panel;
a first mount coupled to the first side of the first panel, the first mount including a recess for receiving excess fabric from the first fabric layer; and
a second mount coupled to the first side of the second panel, the second mount including a recess for receiving excess fabric from the second fabric layer, wherein the second mount engages with the first mount.

29. The screen assembly of claim 28, wherein the first panel is composed of
a plurality of polyester textile yarns from a textile scrap, the plurality of polyester textile yarns being non-homogeneous and having a first melting point that is greater than a first temperature, and
a plurality of staple fibers, the plurality of staple fibers being homogeneous and having a melting point that is less than the first temperature,
wherein the plurality of polyester textile yarns and the plurality of staple fibers are blended and bonded together.

30. The screen assembly of claim 29, wherein the second panel is composed of
a plurality of polyester textile yarns from a textile scrap, the plurality of polyester textile yarns being non-homogeneous and having a first melting point that is greater than a first temperature, and
a plurality of staple fibers, the plurality of staple fibers being homogeneous and having a melting point that is less than the first temperature,
wherein the plurality of polyester textile yarns and the plurality of staple fibers are blended and bonded together.

31. The screen assembly of claim 28, further comprising an attachment coupled to the first panel, wherein the attachment is selected from a group consisting of a frame, a hanging member, and a stand.

32. The screen assembly of claim 31, wherein the first panel includes a recess disposed in the first side of the panel, the recess configured to receive the attachment.

33. The screen assembly of claim 28, wherein the first panel includes a first recess configured to receive the first mount, and wherein the second panel includes a second recess configured to receive the second mount.

34. The screen assembly of claim 28, wherein the first mount is engagable with the second mount to align the first panel and the second panel.

35. The screen assembly of claim 28, wherein the first panel and the second panel are bonded together.

36. The screen assembly of claim 28, wherein the first panel includes a first facing positioned between the second side of the first panel and the first fabric layer, and wherein there second panel includes a second facing positioned between the second side of the second panel and the second fabric layer.

37. The screen assembly of claim 36, wherein the first facing is selected from a group consisting of a resin-impregnated paper and a non-woven scrim, and wherein the second facing is selected from the group consisting of the resin-impregnated paper and the non-woven scrim.

38. The screen assembly of claim 36, wherein the first facing is bonded to the first panel by a polyester-based adhesive, and wherein the second facing is bonded to the second panel by a polyester-based adhesive.
